(19) United States
(12) Patent Application Publication
(10) Pub. No.: US 2020/0341345 A1
(43) Pub. Date: Oct. 29, 2020

(54) MACH-ZEHNDER MODULATOR AND OPTICAL MODULATION DEVICE

(71) Applicant: SUMITOMO ELECTRIC INDUSTRIES, LTD., Osaka (JP)

(72) Inventor: Naoya KONO, Osaka (JP)

(73) Assignee: SUMITOMO ELECTRIC INDUSTRIES, LTD., Osaka (JP)

(21) Appl. No.: 16/852,927

(22) Filed: Apr. 20, 2020

(30) Foreign Application Priority Data
Apr. 26, 2019 (JP) 2019-086296

(51) Int. Cl. G02F 1/225; G02F 1/01

(52) U.S. Cl. CPC G02F 1/2255; G02F 1/011; G02F 2001/212; G02F 2201/12; G02F 1/2257

(57) ABSTRACT

A Mach-Zehnder modulator includes a first arm waveguide; a second arm waveguide; a conductive region for connecting the first arm waveguide and the second arm waveguide to each other; a differential transmission path including a first metal body and a second metal body connected to the first arm waveguide and the second arm waveguide, respectively, and a third metal body for a reference potential; and a capacitor connected between the conductive region and the third metal body.

### CROSS REFERENCE TO RELATED APPLICATIONS

The present application is based upon and claims the benefit of the priority from Japanese patent application No. 2019-086296, filed on Apr. 26, 2019, which is hereby incorporated by reference in its entirety.

### TECHNICAL FIELD

The present disclosure relates to a Mach-Zehnder modulator and an optical modulation device.

### BACKGROUND

U.S. Pat. No. 9,069,223 discloses a Mach-Zehnder optical modulator.

### SUMMARY

The present disclosure provides a Mach-Zehnder modulator including a first arm waveguide; a second arm waveguide; a differential transmission path including a first metal body and a second metal body connected to the first arm waveguide and the second arm waveguide, respectively, and a third metal body for a reference potential; a conductive region for connecting the first arm waveguide and the second arm waveguide to each other; and a capacitor connected between the conductive region and the third metal body.

The present disclosure also provides an optical modulation device including the Mach-Zehnder modulator, an open collector differential drive circuit for driving the Mach-Zehnder modulator, and a terminator connected to the open collector drive circuit via the first metal body and the second metal body of the Mach-Zehnder modulator.

### BRIEF DESCRIPTION OF THE DRAWINGS

The foregoing and other purposes, aspects and advantages will be better understood from the following detailed description of a preferred embodiment of the invention with reference to the drawings, in which:

FIG. 1 is a drawing schematically illustrating an optical modulation device (including a Mach-Zehnder modulator, a drive circuit, and a terminator) according to the present embodiment.

FIG. 2A is a plan view schematically illustrating the Mach-Zehnder modulator according to the present embodiment.

FIG. 2B is a cross-sectional view taken along line IIb-IIb in FIG. 2A.

FIG. 3 is an enlarged view of a part indicated by a dashed line BX1 in FIG. 2A.

FIG. 4A is a cross-sectional view taken along line IVa-IVa indicated in FIG. 3.

FIG. 4B is a cross-sectional view taken along line IVb-IVb indicated in FIG. 3.

FIG. 5 is an enlarged view of a part indicated by a dashed line BX2 in FIG. 2A.

FIG. 6A is a cross-sectional view taken along line VIa-VIa indicated in FIG. 5.

FIG. 6B is a cross-sectional view taken along line VIb-VIb indicated in FIG. 5.

FIG. 7 is a drawing illustrating reflection characteristics of a common mode of the Mach-Zehnder modulator according to an example.

FIGS. 8A, 8B and 8C are drawings illustrating conversion of arrangement of signal lines and grounding lines in an input section.

FIG. 9A is a cross section taken along line IXa-IXa indicated in FIG. 3 and is a drawing illustrating a Mach-Zehnder modulator manufactured by a method for manufacturing a Mach-Zehnder modulator according to the present embodiment.

FIG. 9B is a drawing illustrating a cross section taken along line IXb-IXb indicated in FIG. 3.

FIGS. 10A and 10B are drawings illustrating a main step in the method for manufacturing a Mach-Zehnder modulator according to the present embodiment.

FIGS. 11A and 11B are drawings illustrating a main step in the method for manufacturing a Mach-Zehnder modulator according to the present embodiment.

FIGS. 12A and 12B are drawings illustrating a main step in the method for manufacturing a Mach-Zehnder modulator according to the present embodiment.

FIGS. 13A and 13B are drawings illustrating a main step in the method for manufacturing a Mach-Zehnder modulator according to the present embodiment.

FIGS. 14A and 14B are drawings illustrating a main step in the method for manufacturing a Mach-Zehnder modulator according to the present embodiment.

FIGS. 15A and 15B are drawings illustrating a main step in the method for manufacturing a Mach-Zehnder modulator according to the present embodiment.

FIGS. 16A and 16B are drawings illustrating a main step in the method for manufacturing a Mach-Zehnder modulator according to the present embodiment.

FIGS. 17A and 17B are drawings illustrating a main step in the method for manufacturing a Mach-Zehnder modulator according to the present embodiment.

FIG. 18A is a drawing illustrating a cross section taken along line XVIIIa-XVIIIa indicated in FIG. 5.

FIG. 18B is a cross section taken along line XVIIIb-XVIIIb indicated in FIG. 5 and is a drawing illustrating a Mach-Zehnder modulator manufactured by the method for manufacturing a Mach-Zehnder modulator according to the present embodiment.

FIGS. 19A and 19B are drawings illustrating a main step in the method for manufacturing a Mach-Zehnder modulator according to the present embodiment.

FIGS. 20A and 20B are drawings illustrating a main step in the method for manufacturing a Mach-Zehnder modulator according to the present embodiment.

FIGS. 21A and 21B are drawings illustrating a main step in the method for manufacturing a Mach-Zehnder modulator according to the present embodiment.

FIGS. 22A and 22B are drawings illustrating a main step in the method for manufacturing a Mach-Zehnder modulator according to the present embodiment.

FIGS. 23A and 23B are drawings illustrating a main step in the method for manufacturing a Mach-Zehnder modulator according to the present embodiment.

FIGS. 24A and 24B are drawings illustrating a main step in the method for manufacturing a Mach-Zehnder modulator according to the present embodiment.

FIGS. 25A and 25B are drawings illustrating a main step in the method for manufacturing a Mach-Zehnder modulator according to the present embodiment.

FIGS. 26A and 26B are drawings illustrating a main step in the method for manufacturing a Mach-Zehnder modulator according to the present embodiment.

### DETAILED DESCRIPTION

### Problem to be Solved by the Present Disclosure

U.S. Pat. No. 9,069,223 discloses a Mach-Zehnder optical modulator including strip lines having a plurality of ground surfaces, and a drive circuit connected to the strip lines with a characteristic impedance. The Mach-Zehnder optical modulator receives a differential signal through a transmission path. The differential signal is generated by the drive circuit and is applied to the transmission path of the Mach-Zehnder optical modulator through the characteristic impedance at an output end of the drive circuit.

It is desired to provide a Mach-Zehnder modulator and an optical modulation device capable of reducing a common mode.

### DESCRIPTION OF EMBODIMENTS OF THE PRESENT DISCLOSURE

Subsequently, some specific examples will be described.

A Mach-Zehnder modulator according to a specific example includes (a) a first arm waveguide, (b) a second arm waveguide, (c) a differential transmission path including a first metal body and a second metal body connected to the first arm waveguide and the second arm waveguide, respectively, and a third metal body for a reference potential, (d) a conductive region for connecting the first arm waveguide and the second arm waveguide to each other, and (e) a capacitor connected between the conductive region and the third metal body.

According to the Mach-Zehnder modulator, the first arm waveguide, the conductive region, and the second arm waveguide are connected between the first metal body and the second metal body of the transmission path, and a signal on the transmission path can drive the first arm waveguide and the second arm waveguide. The capacitor is connected between the conductive region and the third metal body and reduces a common mode in the transmission path.

In the Mach-Zehnder modulator according to the specific example, the capacitor includes a first metal-insulator-metal (MIM) element and a second MIM element. The differential transmission path passes between the first MIM element and the second MIM element.

According to the Mach-Zehnder modulator, the first MIM element and the second MIM element are provided on an outer side of the differential transmission path so that a ground surface formed by the differential transmission path is unlikely to be disturbed.

The Mach-Zehnder modulator according to the specific example further includes an additional metal body connected to the conductive region and applying a potential to the conductive region. The conductive region includes a III-V compound semiconductor.

According to the Mach-Zehnder modulator, the additional metal body supplies power to the conductive region independently from a reference potential line. The capacitor stabilizes a potential of power supplied from the metal body and reduces the common mode.

In the Mach-Zehnder modulator according to the specific example, the first metal body has a part extending along the first arm waveguide. The second metal body has a part extending along the second arm waveguide. The third metal body has a part extending between the part of the first metal body and the part of the second metal body.

According to the Mach-Zehnder modulator, the first arm waveguide and the second arm waveguide are driven using an SGS-type transmission path.

An optical modulation device according to a specific example includes (a) the Mach-Zehnder modulator, (b) an open collector-type differential drive circuit for driving the Mach-Zehnder modulator, and (c) a terminator connected to the differential drive circuit via the first metal body and the second metal body of the Mach-Zehnder modulator.

According to the optical modulation device, in the Mach-Zehnder modulator driven by the differential-type open collector drive circuit, the common mode can be reduced.

The Mach-Zehnder modulator may be driven by a back-termination driver and an open collector driver. Specifically, the Mach-Zehnder modulator is connected to an output end of the back-termination driver using a characteristic impedance. Alternatively, the Mach-Zehnder modulator is connected to an output end of the open collector driver without characteristic impedance.

The knowledge of the present disclosure can be understood easily by taking the following detailed description into consideration with reference to the accompanying drawings illustrated as examples. Subsequently, with reference to the accompanying drawings, the optical modulation device and the Mach-Zehnder modulator according to the present embodiment will be described. If possible, the same reference signs are applied to the same parts.

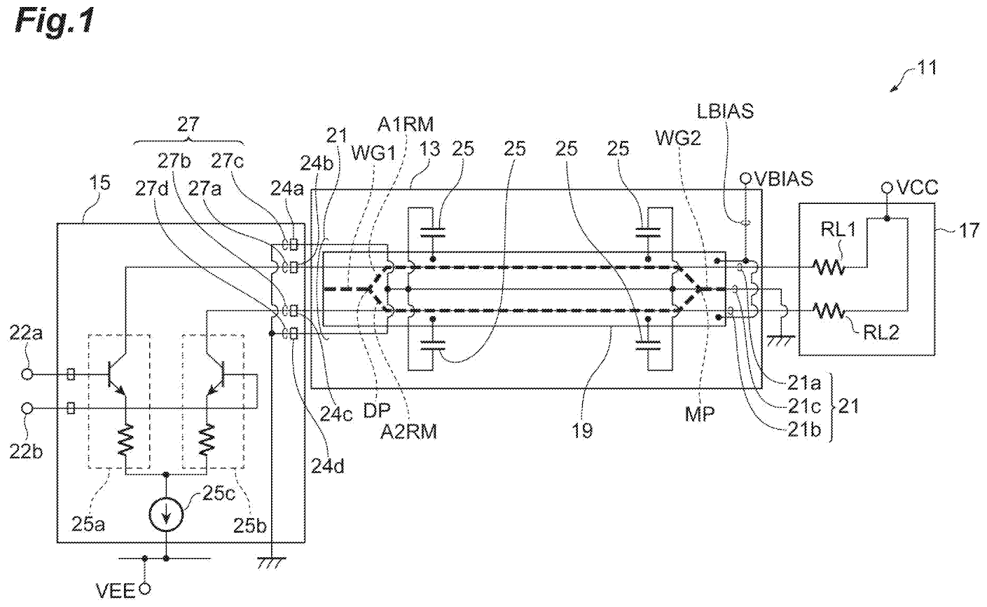

FIG. 1 is a drawing schematically illustrating the optical modulation device according to the present embodiment. An optical modulation device 11 includes a Mach-Zehnder modulator 13, a differential drive circuit 15, and a terminator 17. The Mach-Zehnder modulator 13 and the differential drive circuit 15 may be integrated and form an integrated circuit. In addition, the terminator 17 may be further integrated in these and form an integrated circuit.

The differential drive circuit 15 includes an open collector (or an open drain) differential circuit, and the open collector differential circuit drives the Mach-Zehnder modulator 13 in response to a drive signal received by inputs (22a and 22b). The Mach-Zehnder modulator 13 is connected to the terminator 17 via a transmission line. Specifically, the Mach-Zehnder modulator 13 receives a differential signal from the differential drive circuit 15 at one end thereof and is terminated by the terminator 17 at the other end.

The Mach-Zehnder modulator 13 includes an input waveguide WG1, a splitter DP, a first arm waveguide A1RM, a second arm waveguide A2RM, a multiplexer MP, and an output waveguide WG2. The splitter DP is coupled to the first arm waveguide A1RM and the second arm waveguide A2RM to receive a continuous light beam from the input waveguide WG1 and to provide the first arm waveguide A1RM and the second arm waveguide A2RM with a continuous light beam. The multiplexer MP is coupled to the first arm waveguide A1RM and the second arm waveguide A2RM to multiplex modulation light beams of the first arm waveguide A1RM and the second arm waveguide A2RM and is connected to the output waveguide WG2.

The Mach-Zehnder modulator 13 further includes a conductive region 19 (for example, a conductive semiconductor layer) and transmission paths 21. The conductive region 19 is connected to one end of the first arm waveguide A1RM and one end of the second arm waveguide A2RM and connects the first arm waveguide A1RM and the second arm waveguide A2RM to each other. The transmission paths 21 include a first line 21a and a second line 21b for transmitting a differential signal, and at least one third line 21c. In the present example, a single third line 21c is provided between the first line 21a and the second line 21b, forms the SGS-type transmission path, and is also insulated from the conductive region related to the Mach-Zehnder modulator 13. Specifically, the first line 21a and the second line 21b are respectively connected to the other end of the first arm waveguide A1RM and the other end of the second arm waveguide A2RM. The transmission paths 21 apply differential signals between the other end of the first arm waveguide A1RM and the other end of the second arm waveguide A2RM connected to each other by the conductive region 19. The third line 21c is disposed such that it coincides with the electrical ground surface.

The differential drive circuit 15 generates a modulation signal for modulating light of the Mach-Zehnder modulator 13 from a signal received by the inputs (22a and 22b). Specifically, the differential drive circuit 15 includes a pair of open collector circuits 25a and 25b, a current source 25c (current source circuit), and a transmission line 27. The open collector circuits 25a and 25b are connected to the current source 25c, and the current source 25c is connected to a power source line (for example, VEE). The transmission line 27 includes a pair of signal lines (for example, 27a and 27b) and a pair of grounding lines (for example, 27c and 27d). The first signal line 27a and the second signal line 27b are provided between the first reference potential line 27c and the second reference potential line 27d and form a GSSG-type transmission path. The open collector circuits 25a and 25b are connected to the Mach-Zehnder modulator 13 via the transmission line 27.

The terminator 17 includes a first termination resistor RL1 and a second termination resistor RL2 serving as termination elements. One end of the first termination resistor RL1 and one end of the second termination resistor RL2 are respectively connected to the first line 21a and the second line 21b. The other end of the first termination resistor RL1 and the other end of the second termination resistor RL2 are connected to a power source line (for example, VCC). In the present example, the third line 21c of the transmission paths 21 is not connected to the termination element of the terminator 17.

The Mach-Zehnder modulator 13 integrates capacitors 25 together with the input waveguide WG1, the splitter DP, the first arm waveguide A1RM, the second arm waveguide A2RM, the multiplexer MP, and the output waveguide WG2. The capacitors 25 are connected between the conductive region 19 and the third line 21c. According to the optical modulation device 11, the capacitors 25 are connected between the conductive region 19 and the third line 21c so that the common mode can be reduced in the Mach-Zehnder modulator 13 connected between the differential drive circuit 15 and the terminator 17.

The Mach-Zehnder modulator 13 further includes a bias line LBIAS. The bias line LBIAS is connected to the conductive region 19 and applies a potential to the conductive region 19. The conductive region 19 is connected to a bias voltage source VBIAS.

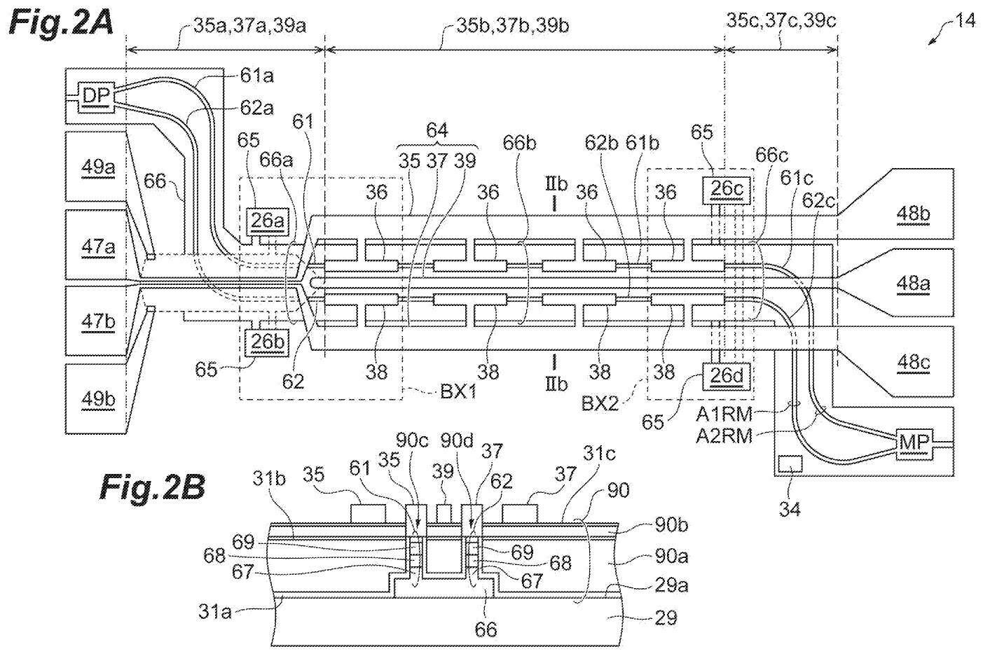

FIG. 2A is a plan view schematically illustrating the Mach-Zehnder modulator according to the present embodiment. FIG. 2B is a cross-sectional view taken along line IIb-IIb in FIG. 2A. For example, the Mach-Zehnder modulator 13 may include a Mach-Zehnder modulator 14 made of a III-V semiconductor.

The Mach-Zehnder modulator 14 includes a first arm waveguide 61, a second arm waveguide 62, differential transmission paths 64, capacitors 65, and a semiconductor layer 66. The first arm waveguide 61 and the second arm waveguide 62 are provided on the semiconductor layer 66. The first arm waveguide A1RM and the second arm waveguide A2RM respectively include the first arm waveguide 61 and the second arm waveguide 62. The conductive region 19 includes the semiconductor layer 66. The semiconductor layer 66 has conductivity.

Each of the first arm waveguide 61 and the second arm waveguide 62 includes an EO modulation portion changing the phases of light beams propagated in the arm waveguides in response to an electrical signal applied from the metal bodies of the differential transmission paths 64.

The differential transmission paths 64 include a first metal body 35, a second metal body 37, and a third metal body 39. The first metal body 35, the second metal body 37, and the third metal body 39 realize the first line 21a, the second line 21b, and the third line 21c. The first metal body 35 and the second metal body 37 are respectively connected to the first arm waveguide 61 and the second arm waveguide 62. The third metal body 39 applies the ground surface of the reference potential to the differential transmission paths 64. The capacitors 65 are connected between the semiconductor layer 66 and the third metal body 39.

The Mach-Zehnder modulator 14 includes a support body 29, and the support body 29 has a main surface 29a including a semi-insulating semiconductor. The semiconductor layer 66 is provided on the main surface 29a.

According to the Mach-Zehnder modulator 14, the first metal body 35 and the second metal body 37 of the differential transmission paths 64 are respectively connected to the first arm waveguide 61 and the second arm waveguide 62 and can drive the first arm waveguide 61 and the second arm waveguide 62. The capacitors 65 are connected between the semiconductor layer 66 and the third metal body 39 and reduce the common mode in the differential transmission paths 64.

The Mach-Zehnder modulator 14 (13) further includes an additional metal body 34. The additional metal body 34 is connected to the semiconductor layer 66 (conductive region 19) and applies a potential to the semiconductor layer 66 (conductive region 19). The additional metal body 34 is connected to the bias voltage source VBIAS illustrated in FIG. 1.

The capacitors 65 include MIM-type capacitance elements. In the present example, the capacitors 25 include four capacitance elements (26a, 26b, 26c, and 26d), for example. The capacitance elements (26a and 26b) of the capacitors 25 are respectively connected to upstream sides of the EO modulation portions of the first arm waveguide 61 and the second arm waveguide 62. The capacitance elements (26c and 26d) of the capacitors 25 are respectively connected to downstream sides of the EO modulation portions of the first arm waveguide 61 and the second arm waveguide 62.

According to the Mach-Zehnder modulator 14, the additional metal body 34 supplies power to the semiconductor layer 66 independently from the reference potential line. The capacitors 65 stabilize a potential of power supplied from the metal body and reduce the common mode.

The semiconductor layer 66 includes a III-V compound semiconductor. The first arm waveguide 61 and the second arm waveguide 62 include a III-V compound semiconductor.

With reference to FIG. 2B, each of the first arm waveguide 61 and the second arm waveguide 62 includes a first conductive semiconductor layer 67, a core layer 68, and a second conductive semiconductor layer 69. The core layer 68 is provided between the first conductive semiconductor layer 67 and the second conductive semiconductor layer 69. The first conductive semiconductor layer 67 and the second conductive semiconductor layer 69 respectively include a lower cladding and an upper cladding.

The Mach-Zehnder modulator 14 may further include an embedding region 90. In the embedding region 90, the semiconductor layer 66, the first arm waveguide 61, and the second arm waveguide 62 are embedded. Specifically, the embedding region 90 may include a resin body and an inorganic insulating film.

The differential transmission paths 64 are provided on the embedding region 90, whereas the capacitors 65 are provided within the embedding region 90. The embedding region 90 can change the levels (heights) of the differential transmission paths 64 to be different from the levels of the capacitors 65. Accordingly, disturbance of high-frequency signals propagated in the differential transmission paths 64 due to the added capacitors 65 can be reduced.

With reference to FIG. 2A, the first metal body 35 has a first part 35a, a second part 35b, and a third part 35c. In the first metal body 35, the first part 35a connects a pad electrode 47a to the second part 35b. The second part 35b extends to the third part 35c along the first arm waveguide 61. The third part 35c connects the second part 35b to a pad electrode 48b. The second part 35b includes a plurality of segment electrodes 36 arranged on the first arm waveguide 61.

The second metal body 37 has a first part 37a, a second part 37b, and a third part 37c. In the second metal body 37, the first part 37a connects a pad electrode 47b to the second part 37b. The second part 37b extends to the third part 37c along the second arm waveguide 62. The third part 37c connects the second part 37b to a pad electrode 48c.

The second part 37b includes a plurality of segment electrodes 38 arranged on the second arm waveguide 62.

The third metal body 39 has a first part 39a, a second part 39b, and a third part 39c. In the third metal body 39, the first part 39a connects a pad electrode 49a (49b) to the second part 39b. The second part 39b extends to the third part 39c along at least one of the first arm waveguide 61 and the second arm waveguide 62. The third part 39c connects the second part 39b to a pad electrode 48a.

The second part 39b of the third metal body 39 may be provided between the second part 35b of the first metal body 35 and the second part 37b of the second metal body 37. According to the Mach-Zehnder modulator 14, the first arm waveguide 61 and the second arm waveguide 62 are driven using the SGS-type differential transmission paths 64.

The first arm waveguide 61 includes a first part 61a, a second part 61b, and a third part 61c which are arranged in order. The first metal body 35 is connected to the second part 61b of the first arm waveguide 61 and forms an EO modulation portion. The second arm waveguide 62 includes a first part 62a, a second part 62b, and a third part 62c which are arranged in order. The second metal body 37 is connected to the second part 62b of the second arm waveguide 62 and forms an EO modulation portion. The semiconductor layer 66 includes a first part 66a, a second part 66b, and a third part 66c which are arranged in order. The first part 66a of the semiconductor layer 66 is equipped with the first part 61a of the first arm waveguide 61 and the first part 62a of the second arm waveguide 62. The second part 66b of the semiconductor layer 66 is equipped with the second part 61b of the first arm waveguide 61 and the second part 62b of the second arm waveguide 62. The third part 66c of the semiconductor layer 66 is equipped with the third part 61c of the first arm waveguide 61 and the third part 62c of the second arm waveguide 62. The capacitors 65 are connected to at least one of the first part 66a and the third part 66c of the semiconductor layer 66.

According to the Mach-Zehnder modulator 14, the semiconductor layer 66 equipped with the first arm waveguide 61 and the second arm waveguide 62 electrically connects the first arm waveguide 61 and the second arm waveguide 62 to each other. High-frequency electricity flowing between the second part 61b of the first arm waveguide 61 and the second part 62b of the second arm waveguide 62 flows in the second part 66b of the semiconductor layer 66.

The capacitors 65 are connected to portions near a border between the first part 66a and the second part 66b of the semiconductor layer 66, and the common mode can be reduced without hindering high-frequency signals applied to the second part 61b of the first arm waveguide 61 and the second part 62b of the second arm waveguide 62. In addition, the capacitors 65 are connected to portions near a border between the second part 66b and the third part 66c of the semiconductor layer 66, and the common mode can be reduced without hindering high-frequency signals applied to the second part 61b of the first arm waveguide 61 and the second part 62b of the second arm waveguide 62.

The capacitors 65 include the first MIM element 26a and the second MIM element 26b. The first MIM element 26a and the second MIM element 26b may be connected to any one of the first part 39a and the third part 39c of the third metal body 39. In the present example, they are connected to the first part 39a of the third metal body 39.

The differential transmission paths 64 pass between the first MIM element 26a and the second MIM element 26b. According to the Mach-Zehnder modulator 14, the first MIM element 26a and the second MIM element 26b are provided on outer sides of the differential transmission paths 64 so that the ground surfaces of the differential transmission paths 64 are unlikely to be disturbed. The first MIM element 26a and the second MIM element 26b are embedded by the embedding region 90 and are positioned on a lower side based on the levels of the ground surfaces of the differential transmission paths 64.

The capacitors 65 include a third MIM element 26c and a fourth MIM element 26d. The third MIM element 26c and the fourth MIM element 26d may be connected to the other of the first part 39a and the third part 39c of the third metal body 39. In the present example, the third MIM element 26c and the fourth MIM element 26d are connected to the third part 39c of the third metal body 39.

The differential transmission paths 64 pass between the third MIM element 26c and the fourth MIM element 26d. According to the Mach-Zehnder modulator 14, the third MIM element 26c and the fourth MIM element 26d are also provided on the outer sides of the differential transmission paths 64 so that the ground surfaces formed by the differential transmission paths are unlikely to be disturbed. The third MIM element 26c and the fourth MIM element 26d are also embedded by the embedding region 90 and are positioned on the lower side based on the level (height) of the ground surface (an upper surface and/or a lower surface of the second part 39b of the third metal body 39).

With reference to FIG. 2B, the embedding region 90 specifically includes a first inorganic insulating film 31a, a second inorganic insulating film 31b, a third inorganic insulating film 31c, a first resin body 90a, and a second resin body 90b. The first inorganic insulating film 31a covers a semiconductor structure including such as the first arm waveguide 61, the second arm waveguide 62, and the semiconductor layer 66. The first arm waveguide 61 and the second arm waveguide 62 are embedded in the first resin body 90a, which has a first opening 90c and a second opening 90d respectively positioned at places of the first arm waveguide 61 and the second arm waveguide 62. The second inorganic insulating film 31b covers the first resin body 90a. The second resin body 90b covers the second inorganic insulating film 31b. The third inorganic insulating film 31c covers the second resin body 90b.

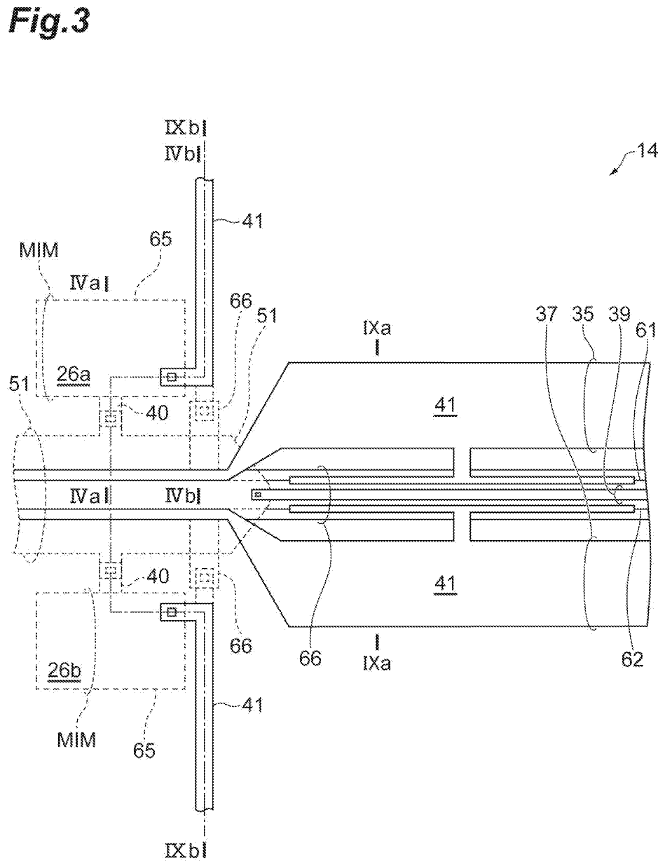

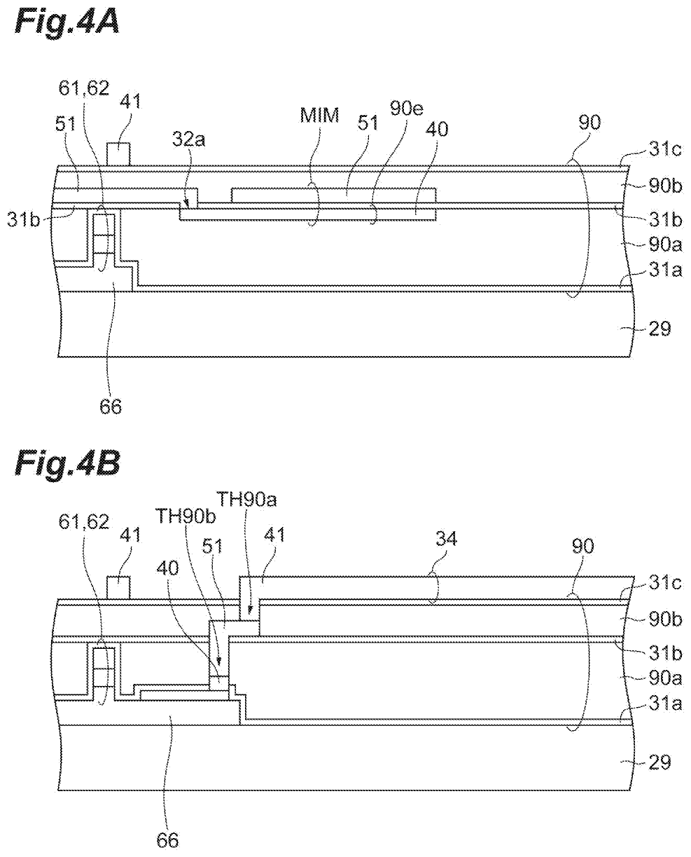

As illustrated in FIGS. 3 and 4A, the capacitors 65 (26a to 26d) are provided utilizing the embedding region 90. The capacitors 65 have a parallel flat plate shape including a lower electrode provided on a surface of the first resin body 90a, an upper electrode provided within the second resin body 90b on the second inorganic insulating film 31b, and the second inorganic insulating film 31b between the lower electrode and the upper electrode.

FIG. 3 is an enlarged view of an area indicated by a dashed line (BX1) in FIG. 2A. FIG. 4A is a cross-sectional view taken along line IVa-IVa indicated in FIG. 3. FIG. 4B is a cross-sectional view taken along line IVb-IVb indicated in FIG. 3.

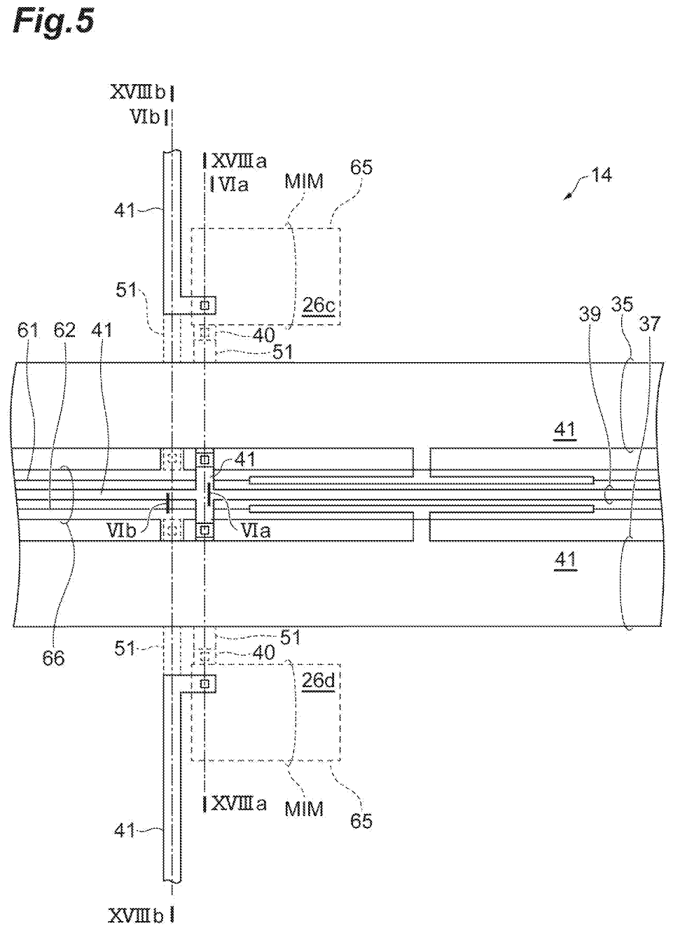

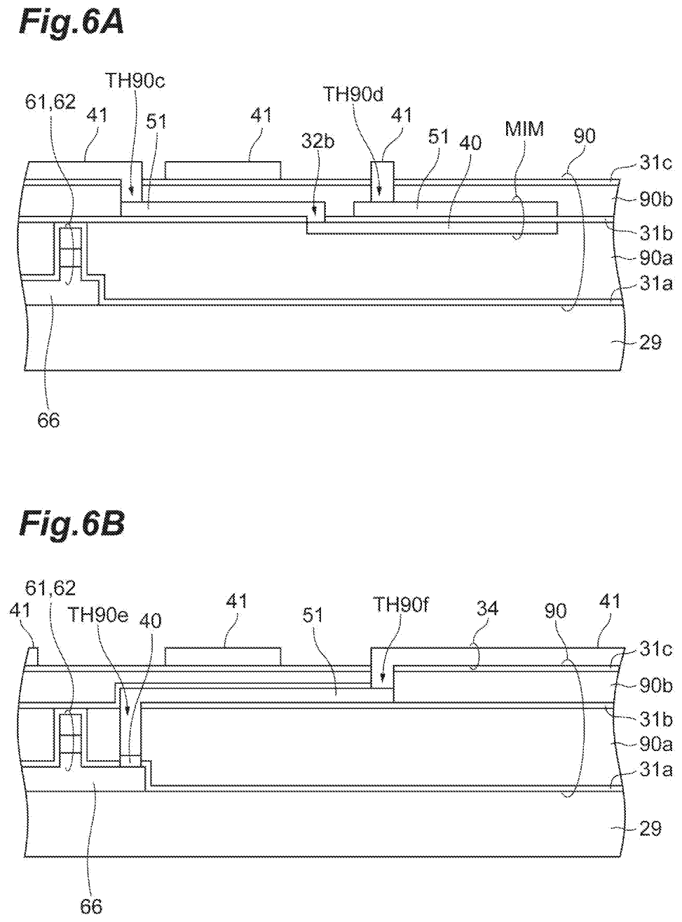

FIG. 5 is an enlarged view of an area indicated by a dashed line (BX2) in FIG. 2A. FIG. 6A is a cross-sectional view taken along line VIa-VIa indicated in FIG. 5. FIG. 6B is a cross-sectional view taken along line VIb-VIb indicated in FIG. 5.

With reference to FIGS. 3 and 5, the Mach-Zehnder modulator 14 has a multi-layer interconnection structure facilitating electrical connection of the first metal body 35, the second metal body 37, and the third metal body 39 and connection between the third metal body 39 and the capacitors 65. The multi-layer interconnection structure includes an upper metal layer 41 provided on the embedding region 90, and an intermediate metal layer 51 and a lower metal layer 40 provided within the embedding region 90.

With reference to FIGS. 4A and 4B, in the capacitors 65 (26a and 26b), the lower electrode includes the lower metal layer 40 provided within a recess 90e on the surface of the first resin body 90a, and the upper electrode includes the intermediate metal layer 51 provided on the first resin body 90a. The second inorganic insulating film 31b is provided between the lower metal layer 40 and the intermediate metal layer 51 and forms each of the capacitors 65 (26a and 26b).

In the present example, the first metal body 35 and the second metal body 37 respectively include the upper metal layers 41. The upper metal layers 41 apply differential signals from the pad electrodes 49a and 49b to the arm waveguides. The third metal body 39 includes the upper metal layer 41 and the intermediate metal layer 51.

Specifically, the second part 39b of the third metal body 39 includes the upper metal layer 41 and extends along the arm waveguide. The first part 39a of the third metal body 39 includes the wide intermediate metal layer 51 extending on the lower sides of the upper metal layers 41 of the first metal body 35 and the second metal body 37. The intermediate metal layer 51 can provide the upper metal layers 41 of the first metal body 35 and the second metal body 37 with wide ground surfaces. In addition, the first part 39a is connected to the lower metal layer 40 of the lower electrode in each of the capacitor MIMs (26a and 26b) via the intermediate metal layer 51. Since the ground surfaces have wide widths, even when the upper metal layers 41 are disposed to cross upper portions of the arm waveguides 61 and 62, potentials of the upper metal layers 41 can be prevented from being disturbed.

The lower metal layer 40 of the lower electrode in each of the capacitors 65 (26a and 26b) is connected to the intermediate metal layer 51 through a penetration hole 32a of the second inorganic insulating film 31b. The intermediate metal layer 51 extends on the lower sides of the upper metal layers 41 of the first metal body 35 and the second metal body 37 to cross the upper metal layers 41.

Specifically, the intermediate metal layer 51 of the upper electrode in each of the capacitors 65 (26a and 26b) is connected to the upper metal layer 41 through a through-hole TH90a of the second resin body 90b and leads to the additional metal body 34. The upper metal layer 41 of the additional metal body 34 is connected to the semiconductor layer 66 via the upper metal layer 41 inside the through-hole TH90a of the second resin body 90b and the intermediate metal layer 51 inside a through-hole TH90b of the first resin body 90a (when necessary, the lower metal layer 40 inside the through-hole TH90b of the first resin body 90a).

With reference to FIGS. 6A and 6B, in the capacitors 65 (26c and 26d), the lower electrode includes the lower metal layer 40, and the upper electrode includes the intermediate metal layer 51. The second inorganic insulating film 31b is provided between the lower metal layer 40 and the intermediate metal layer 51 and forms each of the capacitors 65 (26c and 26d).

In the present example, the first metal body 35 and the second metal body 37 respectively include the upper metal layers 41. The upper metal layers 41 are connected to the pad electrodes 48b and 48c to be connected in order to apply differential signals which have driven the arm waveguides to the terminator 17. The third part 39c of the third metal body 39 includes the upper metal layer 41 and extends between the upper metal layer 41 of the first metal body 35 and the upper metal layer 41 of the second metal body 37.

The lower metal layer 40 of the lower electrode in each of the capacitor MIMs (26c and 26d) is connected to the intermediate metal layer 51 through a penetration hole 32b of the second inorganic insulating film 31b. The intermediate metal layer 51 extends on the lower side of the upper metal layer 41 of the first metal body 35 or the second metal body 37 and is connected to the third part 39c of the third metal body 39 to cross the upper metal layer 41 through a through-hole TH90c of the second resin body 90b.

The intermediate metal layer 51 of the upper electrode in each of the capacitor MIMs (26c and 26d) is connected to the upper metal layer 41 through a through-hole TH90d of the second resin body 90b and leads to the additional metal body 34. The upper metal layer 41 of the additional metal body 34 is connected to the semiconductor layer 66 via the upper metal layer 41 inside a through-hole TH90e of the second resin body 90b and the intermediate metal layer 51 inside a through-hole TH90f of the first resin body 90a (when necessary, the lower metal layer 40 inside the through-hole TH90f of the first resin body 90a).

According to the Mach-Zehnder modulator 14, the first metal body 35, the second metal body 37, and the third metal body 39 can extend at levels different from those of the first MIM element (for example, 26a) and the second MIM element (for example, 26b).

As illustrated in FIG. 1, the differential drive circuit 15 may be provided separately from the Mach-Zehnder modulator 14. The differential drive circuit 15 has the first signal line 27a and the second signal line 27b for differential driving, the first reference potential line 27c, and the second reference potential line 27d. The differential drive circuit 15 has pad electrodes 24a, 24b, 24c and 24d arranged along a lateral side of the element in the order of the first reference potential line 27c, the first signal line 27a, the second signal line 27b, and the second reference potential line 27d in an output section thereof. The first reference potential line 27c and the second reference potential line 27d are connected to the third metal body 39. The first signal line 27a and the second signal line 27b are respectively connected to the first metal body 35 and the second metal body 37.

### Example

Example of Structure of Mach-Zehnder Modulator 14
Upper metal layer 41: gold
Intermediate metal layer 51: gold
Lower metal layer 40: gold
Support body 29: semi-insulating InP
Embedding region 90: resin body and inorganic insulator
First inorganic insulating film 31a: silicon-based inorganic insulating layer, for example, SiO₂
Second inorganic insulating film 31b: silicon-based inorganic insulating layer, for example, SiO₂
Third inorganic insulating film 31c: silicon-based inorganic insulating layer, for example, SiO₂
First resin body 90a and second resin body 90b: BCB resin

Example of First Arm Waveguide 61 and Second Arm Waveguide 62
Semiconductor layer 66: n-type InP, n-type dopant concentration of 1×10¹⁸ cm⁻³, resistance of 1 kilo-ohm (cross section of 30 square micrometers and length of 1 millimeter)
Width of semiconductor layer 66: 50 micrometers
Distance between splitter DP and multiplexer MP: 5 millimeters
Lengths of first arm waveguide 61 and second arm waveguide 62: 4 millimeters
Gap between first arm waveguide 61 and second arm waveguide 62: 25 micrometers
Semiconductor layer 66: n-type InP layer
First conductive semiconductor layer 67: n-type InP layer
Core layer 68: i-type AlGaInAs layer
Second conductive semiconductor layer 69: p-type InP layer and p-type InGaAs layer
Widths of first metal body 35 and second metal body 37: 50 micrometers
Width of third metal body 39: 10 micrometers
Gap between lower electrodes and upper electrodes of capacitors 65 (first MIM element 26a, second MIM element 26b, third MIM element 26c, and fourth MIM element 26d) and intermediate metal layer 51: 10 micrometers
Gap between lower electrodes and upper electrodes of capacitors 65 and nearest upper metal layer 41: 25 micrometers
Capacitors 65 (first MIM element 26a, second MIM element 26b, third MIM element 26c, and fourth MIM element 26d): 1 picofarad per one element

Example of Applied Voltage
Voltage source (VCC): 3 volts
Voltage source (VBIAS): 10 volts
Voltage source (VEE): 0 volts

Each of the first arm waveguide 61 and the second arm waveguide 62 according to the example forms a PIN diode including the first conductive semiconductor layer 67, the core layer 68, and the second conductive semiconductor layer 69. Anodes of the PIN diodes of the first arm waveguide 61 and the second arm waveguide 62 are respectively connected to the first metal body 35 and the second metal body 37. Cathodes of the PIN diodes of the first arm waveguide 61 and the second arm waveguide 62 are connected to the semiconductor layer 66. Power is supplied to the semiconductor layer 66 from the bias voltage source VBIAS through a resistance of the semiconductor layer 66 itself.

The first MIM element 26a and the second MIM element 26b are connected to the outer sides of the EO modulation portions (61b and 62b) of the first arm waveguide 61 and the second arm waveguide 62, that is, in the vicinity of one ends of the EO modulation portions (61b and 62b). The third MIM element 26c and the fourth MIM element 26d are connected to the outer sides of the EO modulation portions (61b and 62b) of the first arm waveguide 61 and the second arm waveguide 62, that is, in the vicinity of the other ends of the EO modulation portions (61b and 62b).

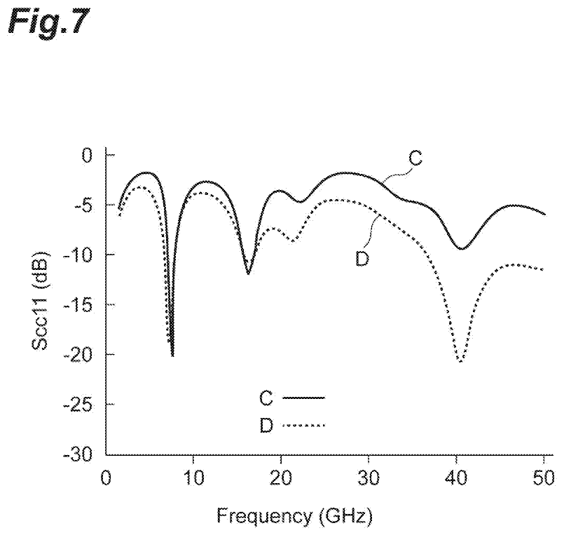

FIG. 7 is a drawing illustrating reflection characteristics of the common mode of the Mach-Zehnder modulator according to the example. A characteristic line D indicates reflection characteristics of the common mode of the Mach-Zehnder modulator according to the example. A characteristic line C indicates reflection characteristics of the common mode of the Mach-Zehnder modulator including none of the capacitors according to the example. The capacitors connected between the conductive region and grounding lines can reduce reflection of the common mode. For example, in a frequency region of 15 GHz or higher, the maximum reflectance of the characteristic line C is −1.8 dB, whereas the maximum reflectance of the characteristic line D is −4.5 dB.

According to an examination of the example and other examinations, the capacitors 65 may have a capacitance within a range of 1 to 100 picofarads.

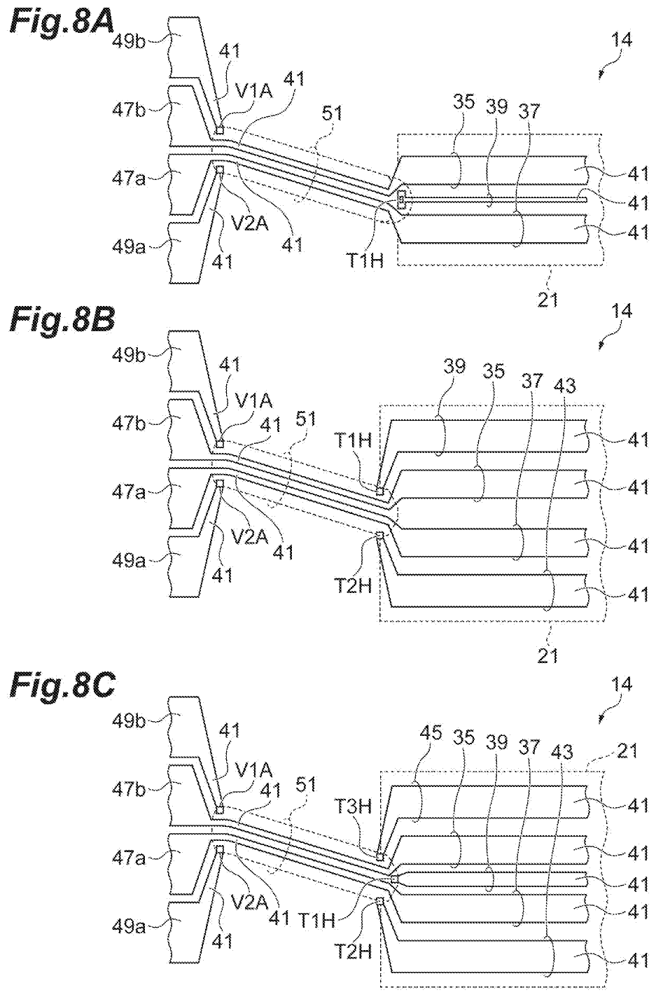

FIGS. 8A, 8B and 8C are drawings illustrating conversion of arrangement of signal lines and the grounding lines in an input section. With reference to FIGS. 8A, 8B, and 8C, differential signals from a driver are applied from the pad electrodes 24a, 24b, 24c and 24d in accordance with arrangement of the signal lines and the grounding lines of the differential drive circuit 15 to the pad electrodes 49b, 47b, 47a, and 49a of the inputs of the Mach-Zehnder modulator 14. The pad electrodes 49a and 49b are connected to the first part 39a of the third metal body 39. The pad electrodes 49a and 49b are connected to one end of the intermediate metal layer 51 having a large common width via the upper metal layers 41. The pad electrodes 47a and 47b are respectively connected to the upper metal layers 41 of the first metal body 35 and the second metal body 37 and extend toward the first arm waveguide 61 and the second arm waveguide 62 on the intermediate metal layer 51 wider than a gap between the upper metal layers 41 parallel to each other.

The parallel upper metal layers 41 and the wide intermediate metal layer 51 can form similar transmission paths in microstrip lines in the first metal body 35 and the second metal body 37. Specifically, in the first part 39a of the third metal body 39, the levels of the upper metal layers 41 from the pad electrodes 49a and 49b are converted into the level of the intermediate metal layer 51 through penetration holes V1A and V2A.

The microstrip line including the upper metal layer 41 of each of the first metal body 35 and the second metal body 37 and the intermediate metal layer 51 of the first part 39a of the third metal body 39 is positioned between the first MIM element 26a and the second MIM element 26b and is unlikely to receive disturbance from the first MIM element 26a and the second MIM element 26b. In the output section, for example, the level of the third part 39c of the third metal body 39 is converted into the level of the intermediate metal layer 51, and the upper metal layer 41 of each of the first metal body 35 and the second metal body 37 extends on the intermediate metal layer 51 of the third part 39c of the third metal body 39 so that a microstrip line can be formed in a similar manner. This microstrip line may be positioned between the third MIM element 26c and the fourth MIM element 26d.

With reference to FIG. 8A, the wide intermediate metal layer 51 in the microstrip line is connected to the second part 39b of the third metal body 39 at the other end thereof. Specifically, the wide intermediate metal layer 51 is connected to the single upper metal layer 41 of the third metal body 39. The single upper metal layer 41 is positioned between the first metal body 35 and the second metal body 37.

As previously described above, the Mach-Zehnder modulator 14 provides each of the first metal body 35 (the first part 35a, the second part 35b, and the third part 35c) and the second metal body 37 (the first part 37a, the second part 37b, and the third part 37c) with the upper metal layer 41. The second part 35b of the first metal body 35 and the second part 37b of the second metal body 37 respectively extend along the first arm waveguide 61 and the second arm waveguide 62. Differential signals on the upper metal layers 41 of the first metal body 35 and the second metal body 37 respectively drive the first arm waveguide 61 and the second arm waveguide 62.

In the second part 39b of the third metal body 39, the intermediate metal layer 51 is connected to the single upper metal layer 41 through a penetration hole T1H. In the first part 35a of the first metal body 35 and the first part 37a of the second metal body 37, the upper metal layers 41 from the pad electrodes 47a and 47b pass above the intermediate metal layer 51 of the first part 39a of the third metal body 39 and reach the second part 35b of the first metal body 35 and the second part 37b of the second metal body 37.

Four input pad electrodes (47a, 47b, 49a, and 49b) are arranged along a lateral side of the element in the order of the upper metal layer 41 of the grounding line, the upper metal layer 41 of the signal line, the upper metal layer 41 of the signal line, and the upper metal layer 41 of the grounding line. This arrangement will be referred to as “GSSG arrangement”. In the first arm waveguide 61 and the second arm waveguide 62, they are arranged in the order of the upper metal layer 41 of the signal line, the upper metal layer 41 of the grounding line, and the upper metal layer 41 of the signal line. This arrangement will be referred to as “SGS arrangement”.

With reference to FIG. 8B, in addition to the third metal body 39, the Mach-Zehnder modulator 14 includes a fourth metal body 43 for a reference potential. Specifically, the Mach-Zehnder modulator 14 provides each of the first metal body 35 (the first part 35a, the second part 35b, and the third part 35c) and the second metal body 37 (the first part 37a, the second part 37b, and the third part 37c) with the upper metal layer 41 and provides each of the third metal body 39 (the second part 39b and the third part 35c) and the fourth metal body 43 (a second part 43b and a third part 43c) with the upper metal layer 41. The second part 35b of the first metal body 35 and the second part 37b of the second metal body 37 respectively extend along the first arm waveguide 61 and the second arm waveguide 62. Differential signals on the upper metal layers 41 of the first metal body 35 and the second metal body 37 respectively drive the first arm waveguide 61 and the second arm waveguide 62. The upper metal layer 41 of the first metal body 35 and the upper metal layer 41 of the second metal body 37 are positioned between the upper metal layer 41 of the third metal body 39 and the upper metal layer 41 of the fourth metal body 43.

The wide intermediate metal layer 51 is connected to the second part 39b of the third metal body 39 and the second part 43b of the fourth metal body 43 at the other end. Specifically, the wide intermediate metal layer 51 is connected to the upper metal layer 41 of the third metal body 39 and the upper metal layer 41 of the fourth metal body 43, and the upper metal layers 41 are positioned on the outer sides of the first metal body 35 and the second metal body 37.

In the first part 39a of the third metal body 39, the levels of the upper metal layers 41 from the pad electrodes 49a and 49b are converted into the level of the intermediate metal layer 51 through the penetration holes V1A and V2A. The intermediate metal layer 51 is connected to the upper metal layer 41 of the second part 39b of the third metal body 39 through the penetration hole T1H and is connected to the upper metal layer 41 of the second part 43b of the fourth metal body 43 through a penetration hole T2H. In the first part 35a of the first metal body 35 and the first part 37a of the second metal body 37, the upper metal layers 41 from the pad electrodes 47a and 47b pass above the single intermediate metal layer 51 and reach the second part 35b of the first metal body 35 and the second part 37b of the second metal body 37. The single intermediate metal layer 51 is shared between the first part 39a of the third metal body 39 and a first part 43a of the fourth metal body 43 and extends at a level different from those of the upper metal layers 41, thereby facilitating power supply to the capacitors 65.

Four input pad electrodes (47a, 47b, 49a, and 49b) are arranged along a lateral side of the element in the order of the upper metal layer 41 of the grounding line, the upper metal layer 41 of the signal line, the upper metal layer 41 of the signal line, and the upper metal layer 41 of the grounding line (GSSG arrangement). This arrangement becomes the arrangement of a pair of upper metal layers 41 of the signal lines extending along the first arm waveguide 61 and the second arm waveguide 62 through an intersection of the upper metal layers 41 and the intermediate metal layer 51 and a pair of upper metal layers 41 of the grounding lines positioned on the outer sides of this pair (GSSG arrangement).

With reference to FIG. 8C, in addition to the third metal body 39, the Mach-Zehnder modulator 14 includes the fourth metal body 43 and a fifth metal body 45 for reference potentials. Specifically, the Mach-Zehnder modulator 14 provides each of the first metal body 35 (the first part 35a, the second part 35b, and the third part 35c) and the second metal body 37 (the first part 37a, the second part 37b, and the third part 37c) with the upper metal layer 41 and provides each of the third metal body 39 (the second part 39b and the third part 35c), the fourth metal body 43 (the second part 43b and the third part 43c), and the fifth metal body 45 (a second part 45b and a third part 45c) with the upper metal layer 41. The second part 35b of the first metal body 35 and the second part 37b of the second metal body 37 respectively extend along the first arm waveguide 61 and the second arm waveguide 62. Differential signals on the upper metal layers 41 of the first metal body 35 and the second metal body 37 respectively drive the first arm waveguide 61 and the second arm waveguide 62. The upper metal layer 41 of the first metal body 35 and the upper metal layer 41 of the second metal body 37 are positioned between the upper metal layer 41 of the fourth metal body 43 and the upper metal layer 41 of the fifth metal body 45, and the upper metal layer 41 of the third metal body 39 is positioned between the upper metal layer 41 of the first metal body 35 and the upper metal layer 41 of the second metal body 37.

The wide intermediate metal layer 51 of the microstrip line is connected to the second part 39b of the third metal body 39, the second part 43b of the fourth metal body 43, and the second part 45b of the fifth metal body 45 at the other end thereof. Specifically, the wide intermediate metal layer 51 is connected to the upper metal layer 41 of the third metal body 39, the upper metal layer 41 of the fourth metal body 43, and the upper metal layer 41 of the fifth metal body 45. The upper metal layers 41 are positioned on the outer sides of the first metal body 35 and the second metal body 37.

The intermediate metal layer 51 is connected to the upper metal layer 41 of the second part 39b of the third metal body 39 through the penetration hole T1H, and the intermediate metal layer 51 is connected to the upper metal layer 41 of the second part 43b of the fourth metal body 43 through the penetration hole T2H. In the first part 35a of the first metal body 35 and the first part 37a of the second metal body 37, the upper metal layers 41 from the pad electrodes 47a and 47b pass above the intermediate metal layer 51 and reach the second part 35b of the first metal body 35 and the second part 37b of the second metal body 37. The intermediate metal layer 51 is shared between the first part 39a of the third metal body 39 and the first part 43a of the fourth metal body 43 and extends at a level different from those of the upper metal layers 41, thereby facilitating power supply to the capacitors 65.

Four input pad electrodes (47a, 47b, 49a, and 49b) are arranged along a lateral side of the element in the order of the upper metal layer 41 of the grounding line, the upper metal layer 41 of the signal line, the upper metal layer 41 of the signal line, and the upper metal layer 41 of the grounding line (GSSG arrangement). This arrangement becomes the arrangement of a pair of upper metal layers 41 of the signal lines extending along the first arm waveguide 61 and the second arm waveguide 62 through an intersection of the upper metal layers 41 and the intermediate metal layer 51, a pair of upper metal layers 41 of the grounding lines positioned on the outer sides of the pair of upper metal layers 41 of the signal lines, and an upper metal layer 41 of the grounding line positioned between a pair of upper metal layers 41 of the signal lines (GSGSG arrangement).

As will be understood from the foregoing description, in the input section and the output section, utilizing of the intermediate metal layer 51 allows any arrangement of “SGS arrangement”, “GSSG arrangement”, and “GSGSG arrangement” to be connected to any arrangement of “SGS arrangement”, “GSSG arrangement”, and “GSGSG arrangement”.

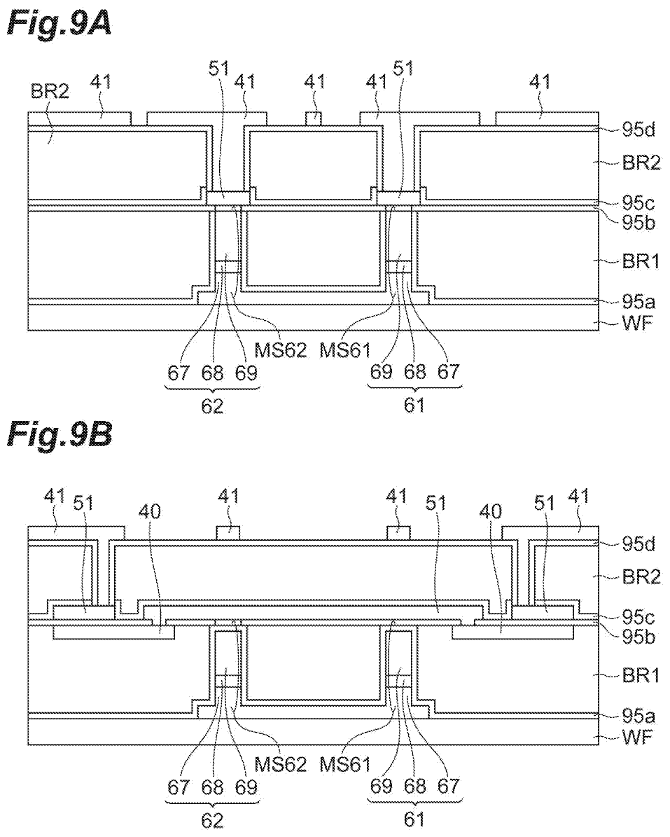

With reference to FIGS. 9A to 26B, main steps in a method for manufacturing a Mach-Zehnder modulator will be described. If possible, in order to facilitate understanding, the reference signs in the description given with reference to FIGS. 1 to 6B will be used.

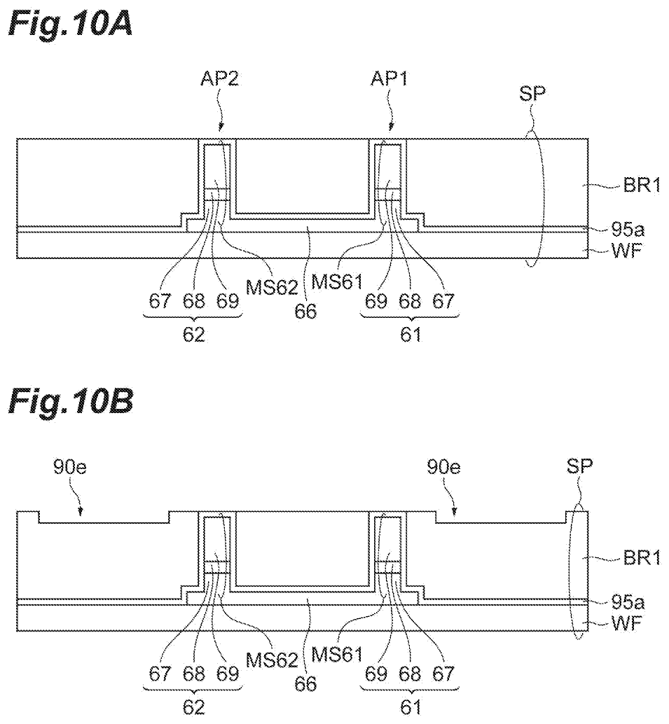

FIG. 9A is a drawing illustrating a cross section taken along line IXa-IXa indicated in FIG. 3. FIG. 9B is a drawing illustrating a cross section taken along line IXb-IXb indicated in FIG. 3. FIGS. 10A, 11A, 12A, 13A, 14A, 15A, 16A, and 17A are drawings illustrating main steps of forming what is shown in a cross section illustrated in FIG. 9A. FIGS. 10B, 11B, 12B, 13B, 14B, 15B, 16B, and 17B are drawings illustrating main steps of forming what is shown in a cross section illustrated in FIG. 9B.

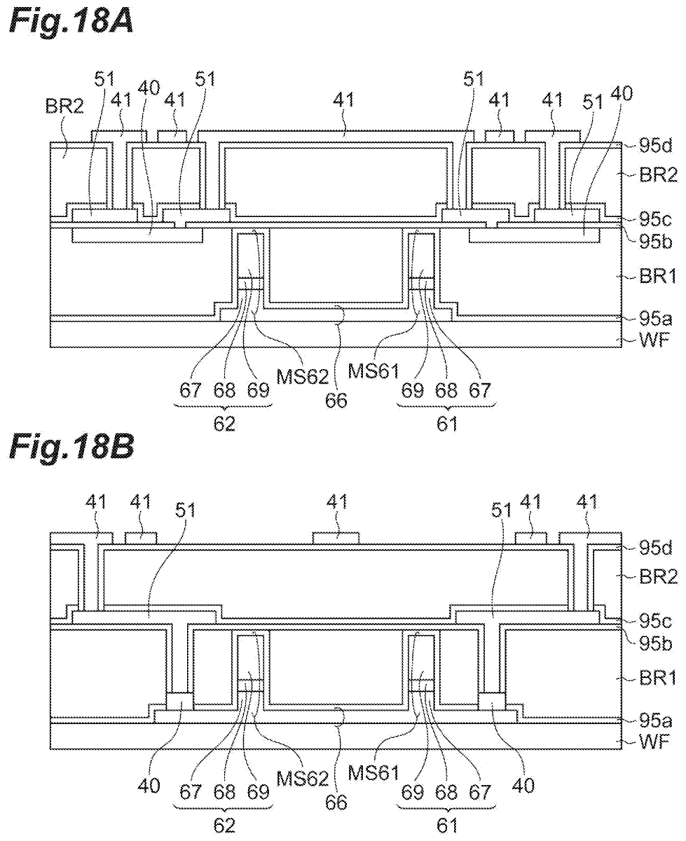

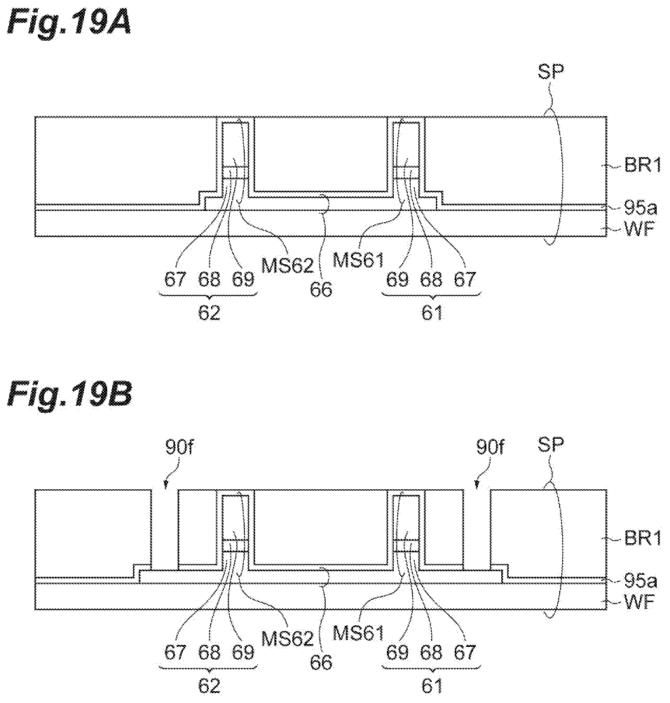

FIG. 18A is a drawing illustrating a cross section taken along line XVIIIa-XVIIIa indicated in FIG. 5. FIG. 18B is a drawing illustrating a cross section taken along line XVIIIb-XVIIIb indicated in FIG. 5. FIGS. 19A, 20A, 21A, 22A, 23A, 24A, 25A, and 26A are drawings illustrating main steps of forming what is shown in a cross section illustrated in FIG. 18A. FIGS. 19B, 20B, 21B, 22B, 23B, 24B, 25B, and 26B are drawings illustrating main steps of forming what is shown in a cross section illustrated in FIG. 18B.

A substrate product SP illustrated in FIGS. 10A, 10B, 19A, and 19B is prepared. The substrate product SP includes a substrate WF, the first arm waveguide 61, the second arm waveguide 62, a lower embedding region BR1, and a first inorganic insulating film 95a. The first arm waveguide 61, the second arm waveguide 62, and the lower embedding region BR1 are provided on the substrate WF. Each of the first arm waveguide 61 and the second arm waveguide 62 includes the first conductive semiconductor layer 67, the core layer 68, and the second conductive semiconductor layer 69 arranged in a normal direction on a main surface of the substrate WF. The first inorganic insulating film 95a covers the first arm waveguide 61 and the second arm waveguide 62. In the lower embedding region BR1 on the substrate WF, the first inorganic insulating film 95a, the first arm waveguide 61, and the second arm waveguide 62 are embedded.

The substrate product SP is manufactured as follows.

Semiconductor layers for the first conductive semiconductor layer 67, the core layer 68, and the second conductive semiconductor layer 69 are grown on the substrate WF of semi-insulating InP, and a semiconductor laminate is formed on the substrate WF. The semiconductor layers may be formed by an organic metal vapor phase growth method or a molecular beam epitaxy method, for example.
Semiconductor layer for first conductive semiconductor layer 67: n-type InP layer
Semiconductor layer for core layer 68: AlGaInAs layer
Semiconductor layer for second conductive semiconductor layer 69: p-type InP layer

A semiconductor laminate is processed through photolithography and etching, and semiconductor mesas (MS61 and MS62) for the first arm waveguide 61 and the second arm waveguide 62 are formed.

Moreover, the semiconductor laminate is subjected to processing for element isolation through photolithography and etching. The semiconductor layer 66 is formed through this processing.

After these steps of processing, the first inorganic insulating film 95a is formed on the entire surface of the substrate WF. The first inorganic insulating film 95a includes silicon-based inorganic substances such as SiO₂, SiON, and SiN. The upper part of the first inorganic insulating film 95a is coated with a resin and desired processing is performed, thereby forming the lower embedding region BR1. The lower embedding region BR1 includes a resin body, and the resin body includes BCB or polyimide, for example. The lower embedding region BR1 has openings AP1 and AP2 for exposing the upper surfaces of the first arm waveguide 61 and the second arm waveguide 62.

After the substrate product SP is prepared, as illustrated in FIGS. 10A, 10B, 19A, and 19B, penetration holes 90f for connection paths from recessed portions 90e for the lower electrodes of the capacitors 65 and the upper electrodes of the capacitors 65 to the semiconductor layer 66 are formed. Specifically, the recessed portions 90e are formed in the lower embedding region BR1 using photolithography and etching. The recessed portion 90e has a bottom surface and side surfaces of the resin body. In addition, the penetration holes 90f are formed in the lower embedding region BR1 using photolithography and etching. The penetration holes 90f reach the semiconductor layer 66, and the semiconductor layer 66 is visible through the penetration holes 90f.

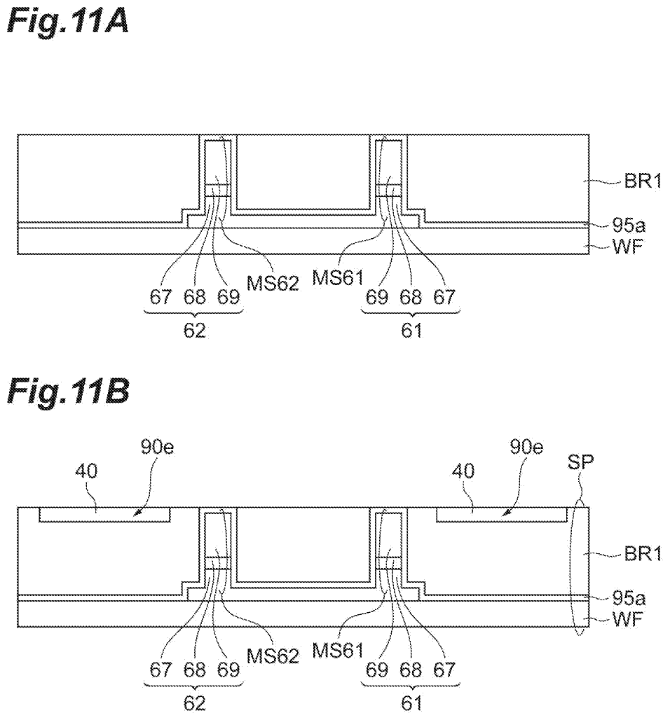

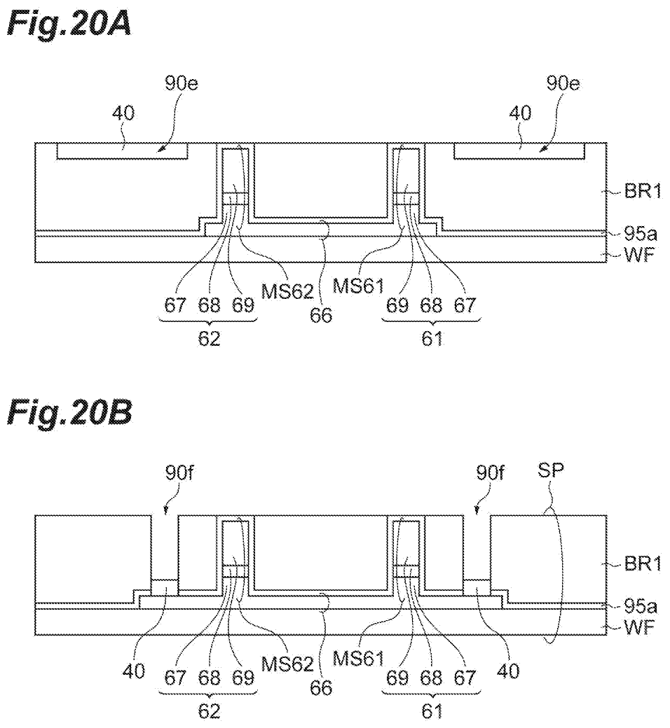

After the recessed portions 90e and the penetration holes 90f are formed in the substrate product SP, as illustrated in FIGS. 11A, 11B, 20A, and 20B, the lower metal layers 40 are formed within the recessed portions 90e (when necessary, within the penetration holes 90f) through lift-off using photolithography and deposition. Metal films for the lower metal layers 40 are grown by a deposition method such as plating, for example, and include gold, for example.

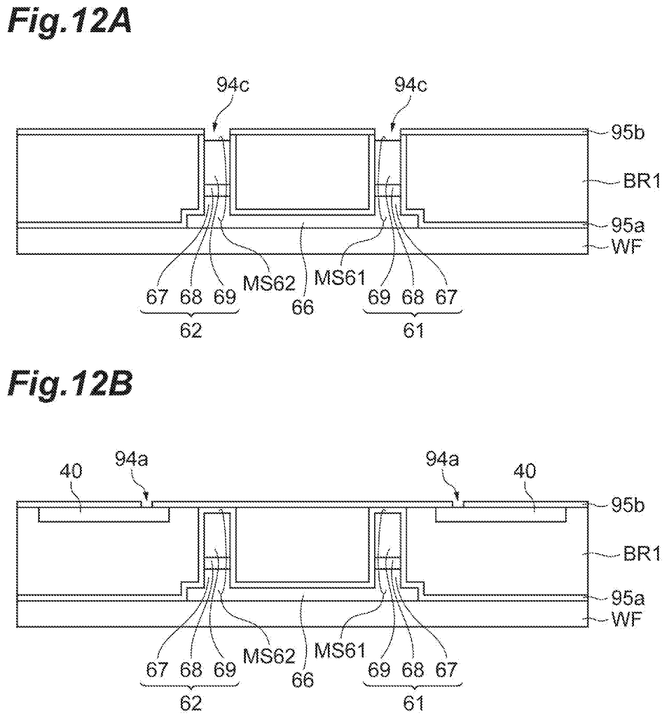

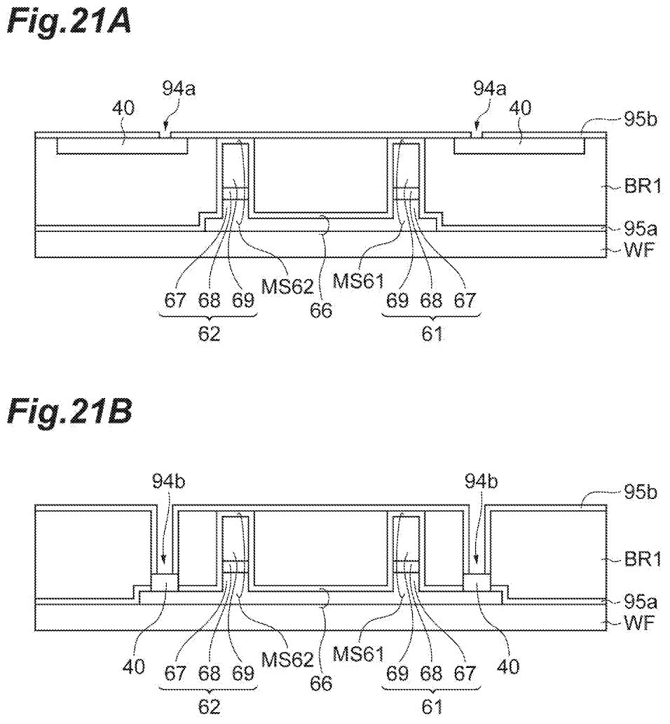

After the metal films for the lower metal layers 40 are deposited, as illustrated in FIGS. 12A, 12B, 21A, and 21B, a second inorganic insulating film 95b is formed on the lower embedding region BR1 of the substrate product SP. The second inorganic insulating film 95b may include silicon-based inorganic substances such as SiO₂, SiON, and SiN and may be deposited by a chemical vapor deposition method, for example. An insulating film for the second inorganic insulating film 95b is utilized as a dielectric of an MIM capacitor and covers the lower metal layers 40 for the lower electrodes.

An insulating film for the second inorganic insulating film 95b is subjected to processing using photolithography and etching, and penetration holes 94a and 94b positioned on the lower metal layers 40 are formed. The penetration holes 94a are positioned on the lower metal layers 40 for the lower electrodes and reach the lower metal layers 40. The penetration holes 94b are positioned on the semiconductor layer 66 inside the penetration holes 90f and reach the semiconductor layer 66.

In addition, at the same time as this processing or through separate processing using photolithography and etching, penetration holes 94c reaching the upper surfaces of the first arm waveguide 61 and the second arm waveguide 62 are formed in the first inorganic insulating film 95a and the second inorganic insulating film 95b.

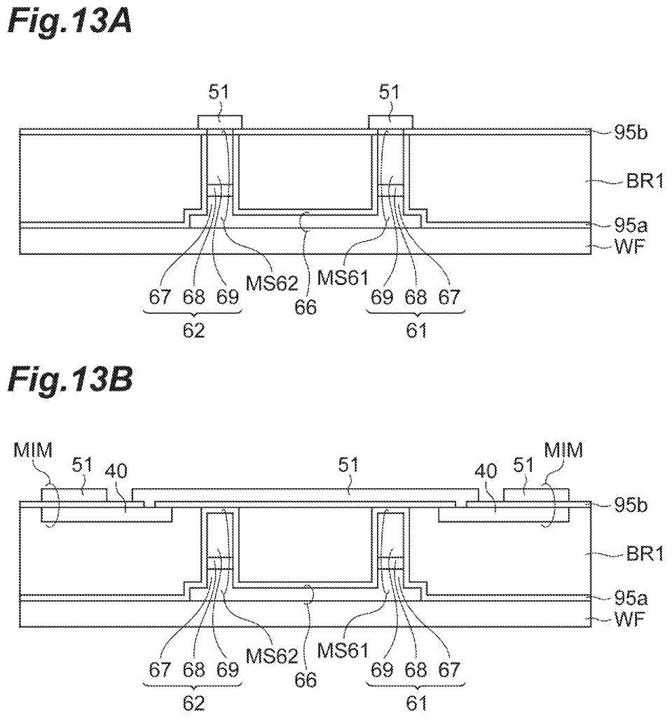

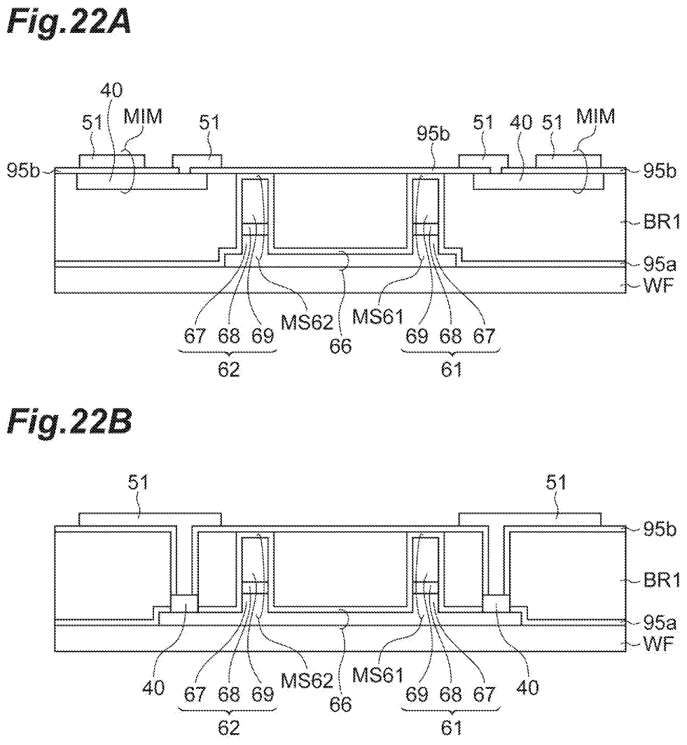

After the penetration holes 94a, 94b, and 94c are formed, as illustrated in FIGS. 13A, 13B, 22A, and 22B, the intermediate metal layer 51 is formed. Specifically, a metal film for the intermediate metal layer 51 is grown by a deposition method such as plating, for example, and includes gold, for example. The intermediate metal layer 51 may be formed through lift-off using photolithography, deposition, and etching, for example. Specifically, the intermediate metal layer 51 is provided on a dielectric film for a capacitor MIM and the penetration holes 94c on the upper surfaces of the first arm waveguide 61 and the second arm waveguide 62. In addition, the intermediate metal layer 51 is provided on the second inorganic insulating film 95b and forms a supply line of a bias voltage to the first part 39a of the third metal body 39 and the semiconductor layer 66 and a connection line for the upper electrode and the lower electrode of the capacitor MIM.

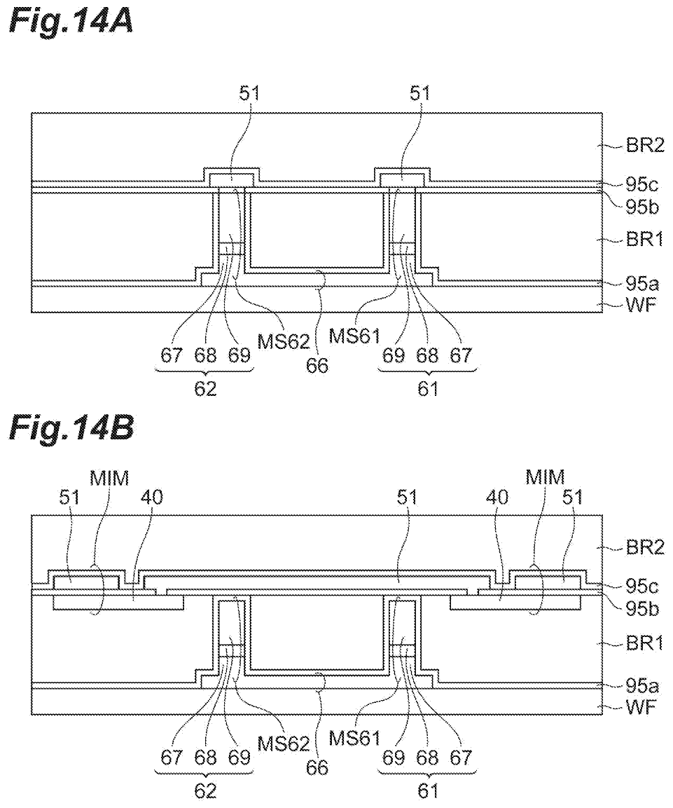

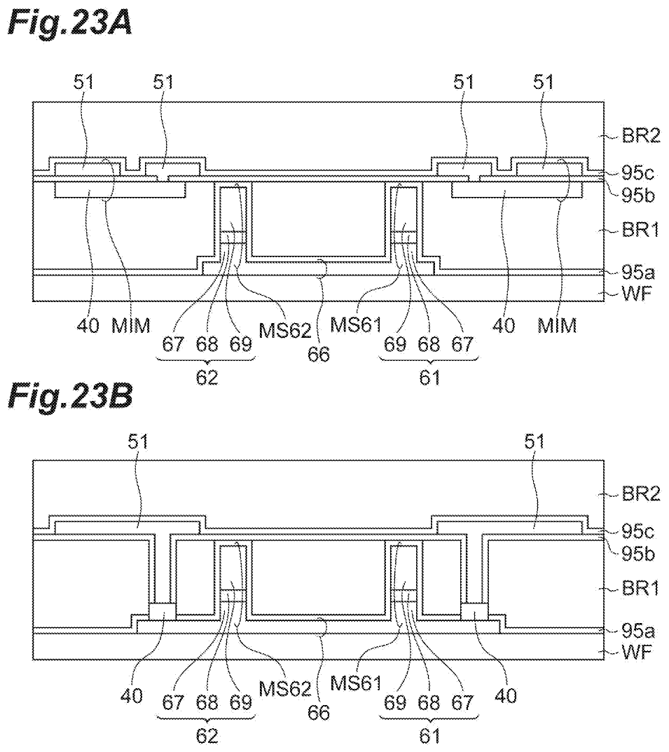

After the intermediate metal layer 51 is formed, as illustrated in FIGS. 14A, 14B, 23A, and 23B, the intermediate metal layer 51 is coated with a resin such that it is covered, and an upper embedding region BR2 is formed. The upper embedding region BR2 includes a resin body, and the resin body includes BCB or polyimide, for example. The upper embedding region BR2 has substantially a flat upper surface with an embedded capacitor MIM. In addition, the upper embedding region BR2 allows the capacitor MIM to be positioned separately from the upper metal layer 41 to be produced in a subsequent step, and this separate positioning reduces disturbance of electrical signals on the first metal body 35 and the second metal body 37 due to the capacitor MIM. When necessary, prior to forming the upper embedding region BR2, a coated inorganic insulating film 95c is formed on the entire surface of the substrate WF through vapor phase epitaxy. The coated inorganic insulating film 95c includes silicon-based inorganic substances such as SiO₂, SiON, and SiN.

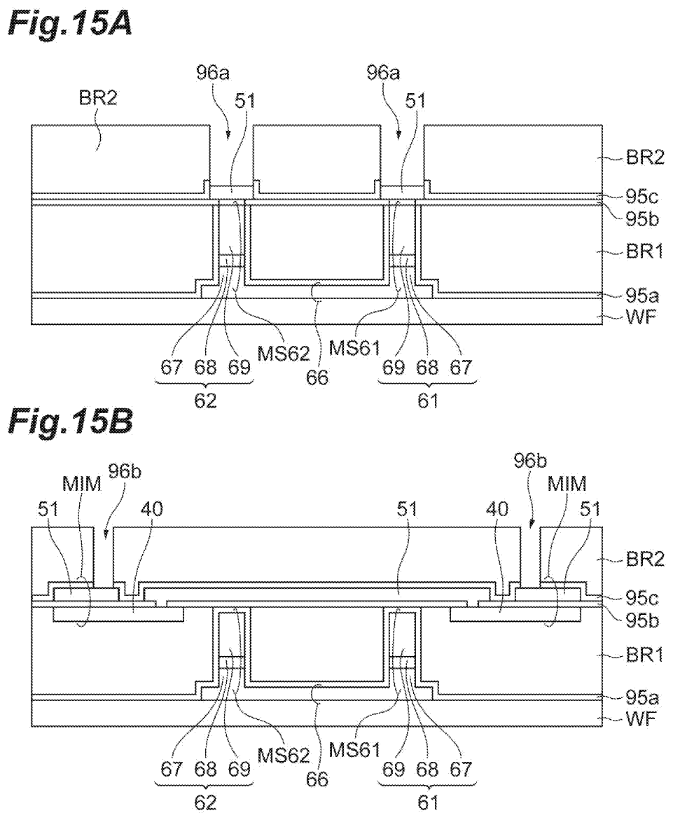

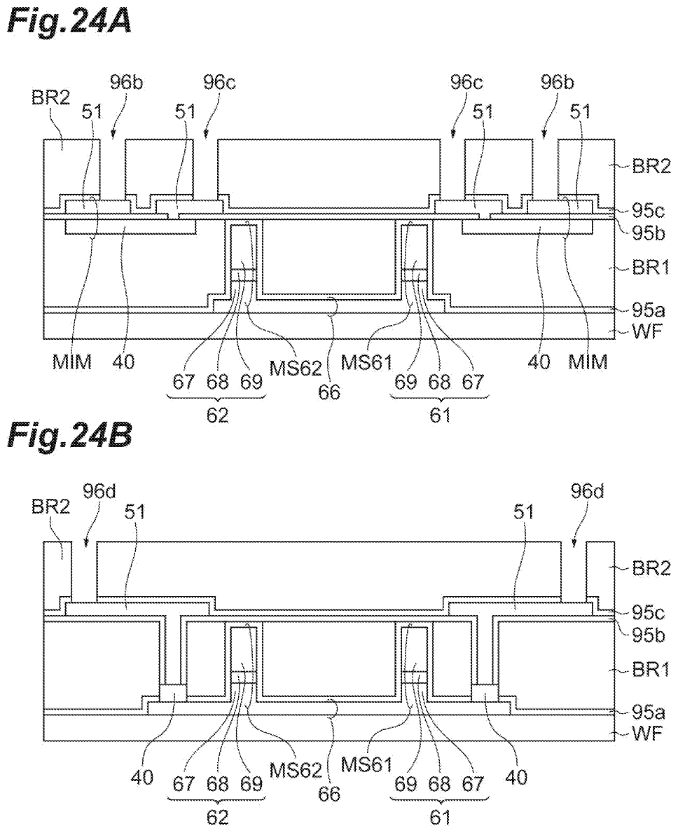

After the coated inorganic insulating film 95c and the upper embedding region BR2 are formed, as illustrated in FIGS. 15A, 15B, 24A, and 24B, penetration holes 96a, 96b, 96c and 96d are formed in the coated inorganic insulating film 95c and the upper embedding region BR2 through processing including photolithography and etching. The penetration hole 96a reaches the upper surfaces of the first arm waveguide 61 and the second arm waveguide 62. The penetration hole 96b reaches the upper electrode (intermediate metal layer 51) of the capacitor MIM. The penetration hole 96c reaches the intermediate metal layer 51 connected to the lower electrodes (lower metal layers 40) of the capacitor MIM. The penetration hole 96d reaches the intermediate metal layer 51 connected to the semiconductor layer 66.

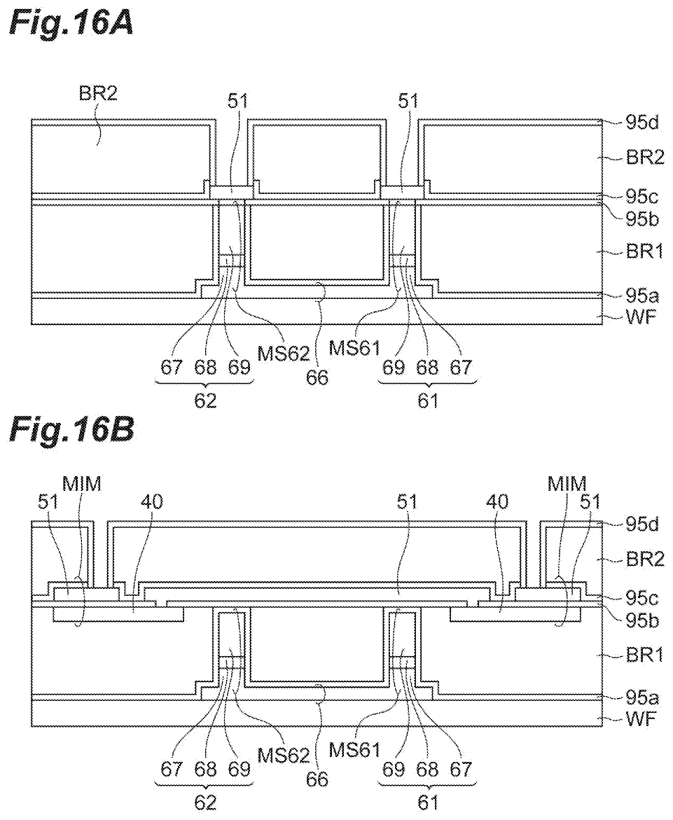

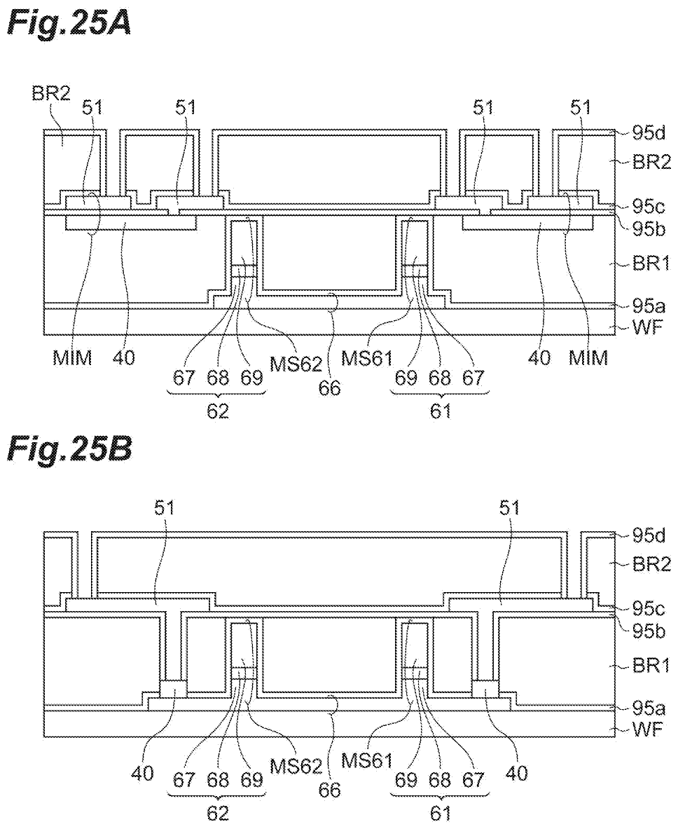

After the coated inorganic insulating film 95c and the upper embedding region BR2 are processed, as illustrated in FIGS. 16A, 16B, 25A, and 25B, an insulating film for a third inorganic insulating film 95d is formed on the entire surface of the substrate WF through vapor phase epitaxy. An opening reaching the intermediate metal layer 51 of the penetration holes 96a, 96b, 96c and 96d is formed in the insulating film for the third inorganic insulating film 95d through photolithography and etching, thereby obtaining the third inorganic insulating film 95d. The third inorganic insulating film 95d includes silicon-based inorganic substances such as SiO₂, SiON, and SiN.

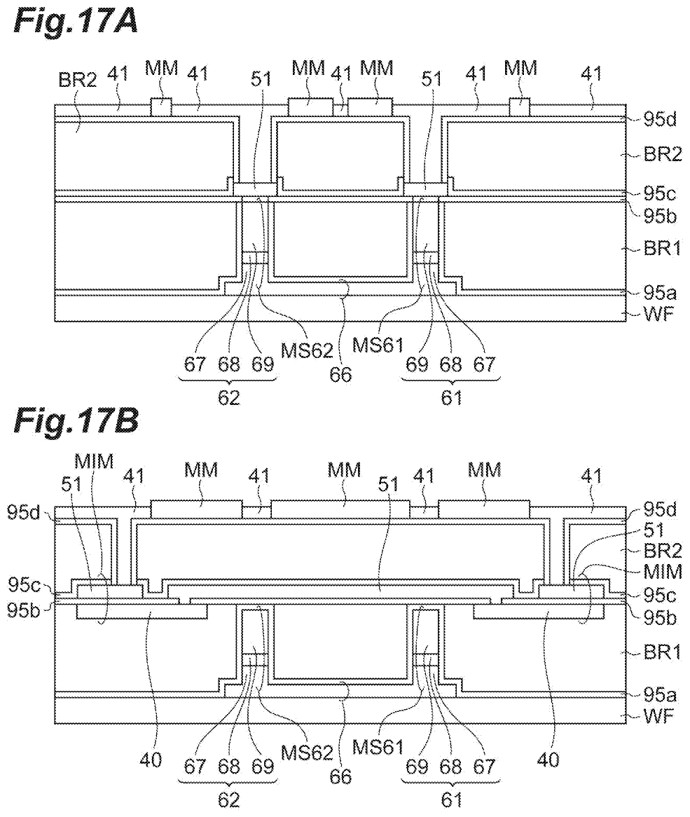

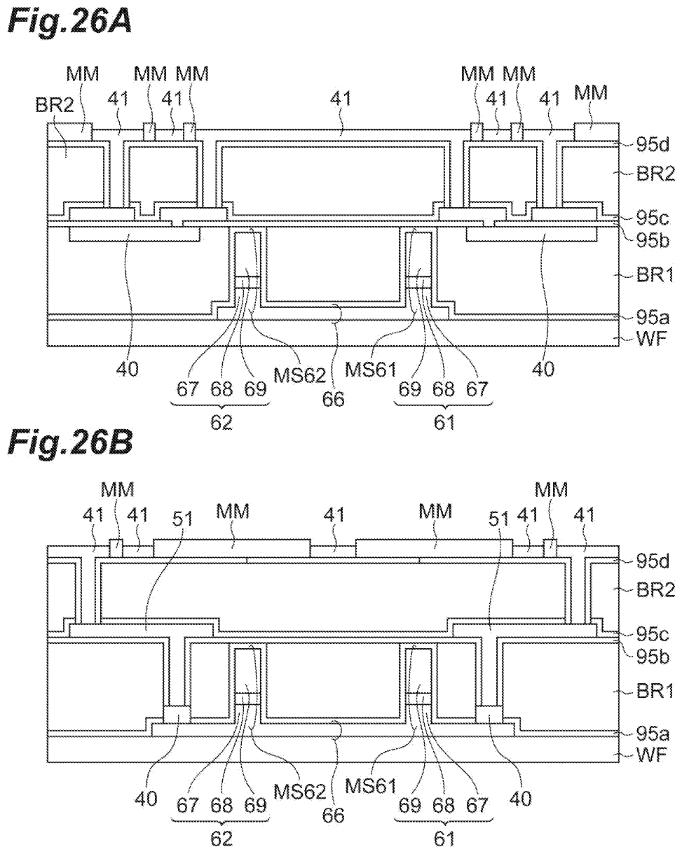

After the third inorganic insulating film 95d is formed, as illustrated in FIGS. 17A, 17B, 26A, and 26B, the upper metal layer 41 is formed. Specifically, a metal film for the upper metal layer 41 is grown by a deposition method such as plating, for example, and includes gold, for example. The upper metal layer 41 may be formed through photolithography and deposition, for example. This deposition may be performed by a plating method, for example, and a pattern of the upper metal layer 41 is defined using a mask MM. After the upper metal layer 41 is formed, the mask MM is removed.

Through these steps, the Mach-Zehnder modulator 14 illustrated in FIGS. 9A, 9B, 18A, and 18B is completed.

The principle of the present disclosure has been illustrated and described with a preferable embodiment. However, those skilled in the art will recognize that the present disclosure can be changed in disposition and details without departing from the foregoing principle. The present disclosure is not limited by any specific constitution disclosed the present embodiment. Therefore, the rights are claimed on all the modifications and the changes from the claims and the scope of the spirit thereof.

As described above, according to the present embodiment, it is possible to provide a Mach-Zehnder modulator capable of reducing a common mode, and an optical modulation device including the Mach-Zehnder modulator.

What is claimed is:

1. A Mach-Zehnder modulator comprising:
a first arm waveguide;
a second arm waveguide;
a differential transmission path including a first metal body and a second metal body connected to the first arm waveguide and the second arm waveguide, respectively, and a third metal body for a reference potential;
a conductive region for connecting the first arm waveguide and the second arm waveguide to each other; and
a capacitor connected between the conductive region and the third metal body.

2. The Mach-Zehnder modulator according to claim 1,
wherein the capacitor includes a first metal-insulator-metal element and a second metal-insulator-metal element, and
wherein the differential transmission path passes between the first metal-insulator-metal element and the second metal-insulator-metal element.

3. The Mach-Zehnder modulator according to claim 1 further comprising:
an additional metal body connected to the conductive region and applying a potential to the conductive region,
wherein the conductive region includes a III-V compound semiconductor.

4. The Mach-Zehnder modulator according to claim 1,
wherein the first metal body includes a part extending along the first arm waveguide,
wherein the second metal body includes a part extending along the second arm waveguide, and
wherein the third metal body includes a part extending between the part of the first metal body and the part of the second metal body.

5. An optical modulation device comprising:
the Mach-Zehnder modulator according to claim 1;
an open collector-type differential drive circuit for driving the Mach-Zehnder modulator; and
a terminator connected to the differential drive circuit via the first metal body and the second metal body of the Mach-Zehnder modulator.
